(19) United States
(12) Patent Application Publication
(10) Pub. No.: US 2016/0046313 A1
(43) Pub. Date: Feb. 18, 2016

(54) Cover for Alternate Shopping Cart Handle Enveloping and Compact Storage

(71) Applicant: Michael Landwehr, Derby, KS (US)

(72) Inventor: Michael Landwehr, Derby, KS (US)

(21) Appl. No.: 14/926,813

(22) Filed: Oct. 29, 2015

(51) Int. Cl. B62B 5/06

(52) U.S. Cl. CPC B62B 5/069

(57) ABSTRACT

A handle cover for alternate storage within a purse or baby bag and envelopment of a shopping cart handle, the handle cover incorporating a laterally extending series of Hunter springs, each Hunter spring among the series being alternatively normally radially inwardly curved and normally spirally curved; at least a first flexible sheet; and adhesive bonds which mount the laterally extending series of Hunter springs upon the at least first flexible sheet, the bonds arranging the laterally extending series of Hunter springs for, upon initially radially inwardly curving of the springs, upon an adjacent positioning of the at least first flexible sheet with respect to the shopping cart handle, and upon subsequent radially outward straightenings of the springs, spirally wrapping the springs and the at least first flexible sheet around the shopping cart handle.

### FIELD OF THE INVENTION

This invention relates to shopping carts and shopping cart handles. More particularly, this invention relates to protective covers for shopping cart handles.

### BACKGROUND OF THE INVENTION

Cylindrical “snap on” type shopping cart handle covers are known. Such covers commonly serve functions of protecting against and resisting transmission of pathogens from a shopping cart's handle surfaces to a shopper or to a baby or toddler seated in the shopping cart. A problem or defect associated with such shopping cart handle covers is associated with dimensional inconsistencies between common shopping cart handles and the interior spaces of purses and baby bags which are commonly carried by the shoppers who use shopping carts.

Typical lateral widths of shopping cart handles are between 22″ and 34″, while the interior spaces of shoppers' purses and baby bags typically commonly have markedly smaller dimensions. Accordingly, snap-on shopping cart handle covers which are conventionally sized for use upon shopping cart handles typically are too large for insertion into and storage within such purses or baby bags. Such size conflicts undesirably result in shoppers' foregoing of utilization of any cart handle cover.

The instant inventive shopping cart handle cover solves or ameliorates the problems discussed above by incorporating within the cover of a series of specialized springs which dually or alternatively function for cart handle enveloping and for securing the cover in a compact purse or baby bag storage configuration.

### BRIEF SUMMARY OF THE INVENTION

A first structural component of the instant inventive cover for alternate compact storage and a shopping cart handle enveloping comprises a laterally extending series of Hunter, Neg'ator, constant force, or spiral rarefaction springs (hereinafter referred to as Hunter or constant force springs). In the preferred embodiment, the Hunter springs both normally radially inwardly curve and normally spirally curve, such normal curvatures being alternative to each other and the planes of such curves being orthogonal to each other.

Further structural components of the instant inventive handle cover comprise means for securely mounting the laterally extending Hunter spring series upon a preferably rectangular and laterally oblongated flexible sheet. In a preferred embodiment, such means comprise adhesive bonds. Suitably, such means may alternatively comprise stitched seams or spring receiving pockets or slots formed within the at least first flexible sheet.

In the preferred embodiment, the springs' mounting means arrange the specialized Hunter springs for, upon initial radially inward curvatures of said springs (i.e., a first normal spring positioning), upon adjacent positionings of the flexible sheet and springs with respect to and along a shopping cart handle, and upon subsequent bending induced radially outward straightenings of said springs, releasing the springs for alternate or second normal spring biased movements toward their spirally curved configurations. Such spring released spiraling advantageously wraps the springs and the at least first flexible sheet around the shopping cart handle to form a substantially cylindrical handle cover.

The instant invention's provision of the laterally extending series of Hunter springs preferably forms within the at least first flexible sheet a mid-line living hinge which allows an over-folding or doubling of the sheet. Such sheet over-folding effectively halves the sheet's size while allowing the extended constant force springs (in their first normal positions) within each sheet half to reinforce and prevent spiraling movements of the opposite halves' springs. Thus, while the inventive handle cover resides at its compact over-folded configuration, its specially configured constant force springs retain the sheet at the compact storage configuration. The springs' complimentary self maintenance of the covers' compact storage configuration allows a shopper to easily and conveniently store the cover within a purse or a baby bag, without the risk of any spiraling spring release within the bag.

Accordingly, objects of the instant invention include the provision of a handle cover for alternate compact storage and envelopment of a shopping cart handle which incorporates structures as described above, and which arranges those structures in relation to each other in manners described above for performance of the functions and for achievement of the benefits described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 presents a perspective view of the instant inventive cover for alternate compact storage and a shopping cart handle envelopment, the view further showing a shopping cart having a handle upon which the cover may be installed.

FIG. 2 redepicts the structure of FIG. 1, the view of FIG. 2 showing the inventive handle cover installed upon the shopping cart handle.

FIG. 3 is a magnified partial view, as indicated in FIG. 1.

FIG. 4 is a sectional view, as indicated in FIG. 3.

FIG. 5 is a magnified partial view, as indicated in FIG. 4.

FIG. 6 presents an alternate compact storage configuration of the inventive handle cover.

FIG. 7 is a sectional view, as indicated in FIG. 6.

FIG. 8 is a perspective view of a specialized Hunter spring component of the instant invention.

FIG. 9 presents an alternate configuration of the spring of FIG. 8.

### DETAILED DESCRIPTION OF A PREFERRED EMBODIMENT

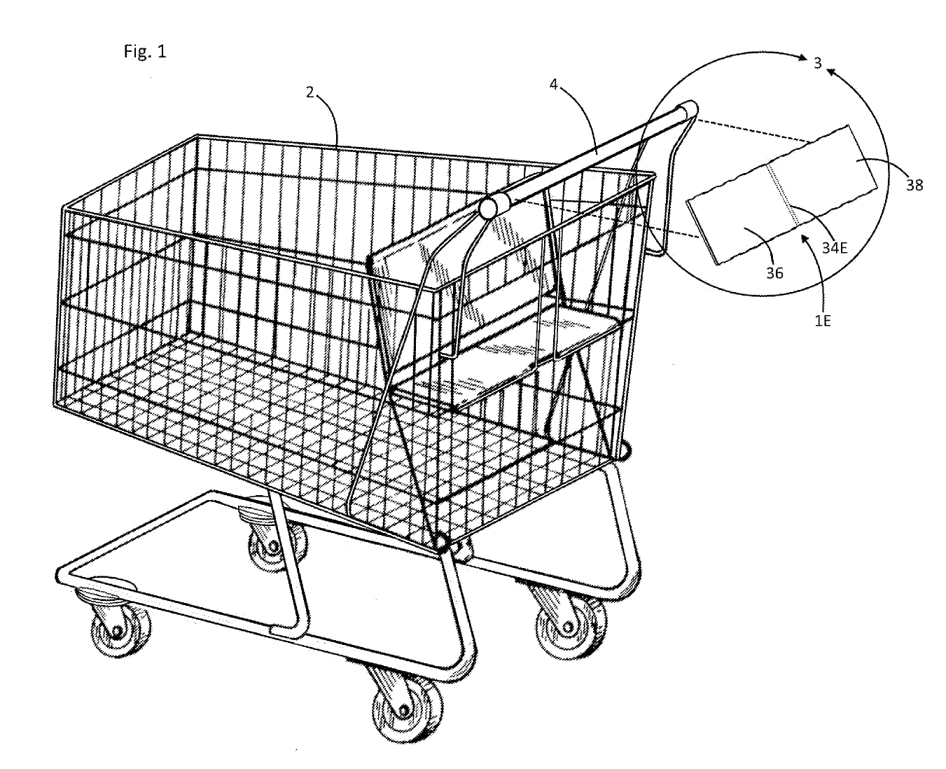

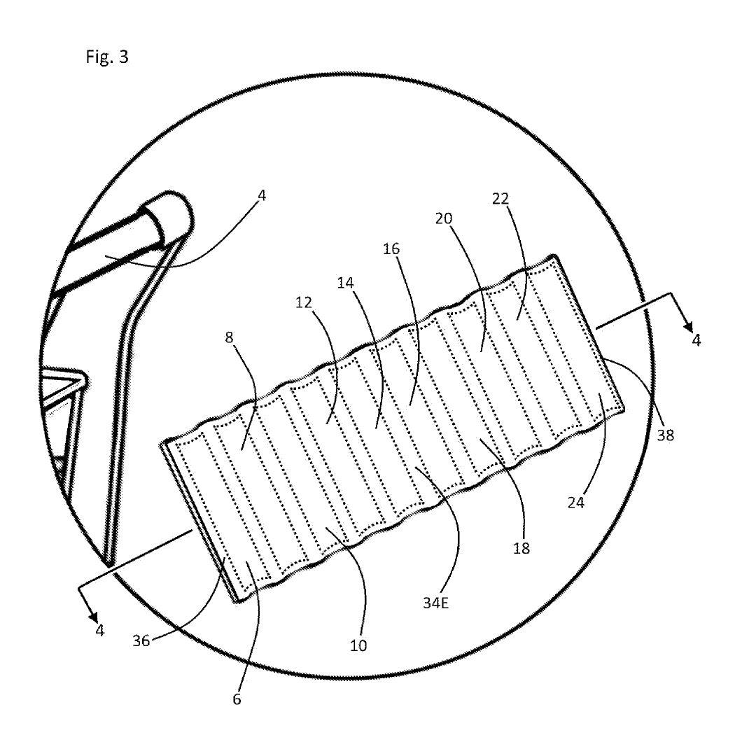

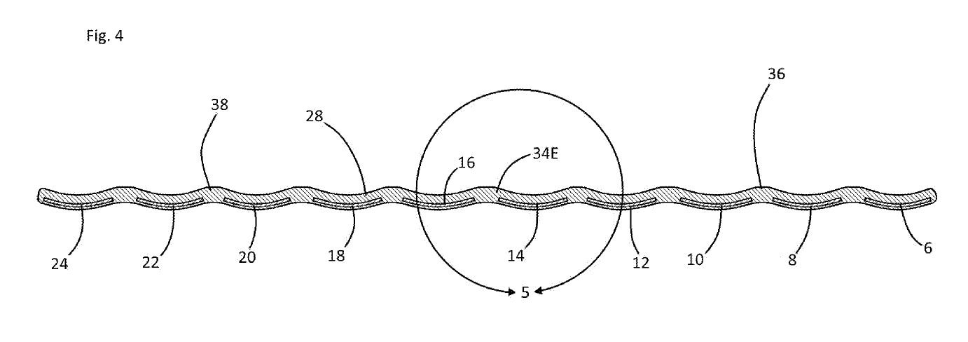

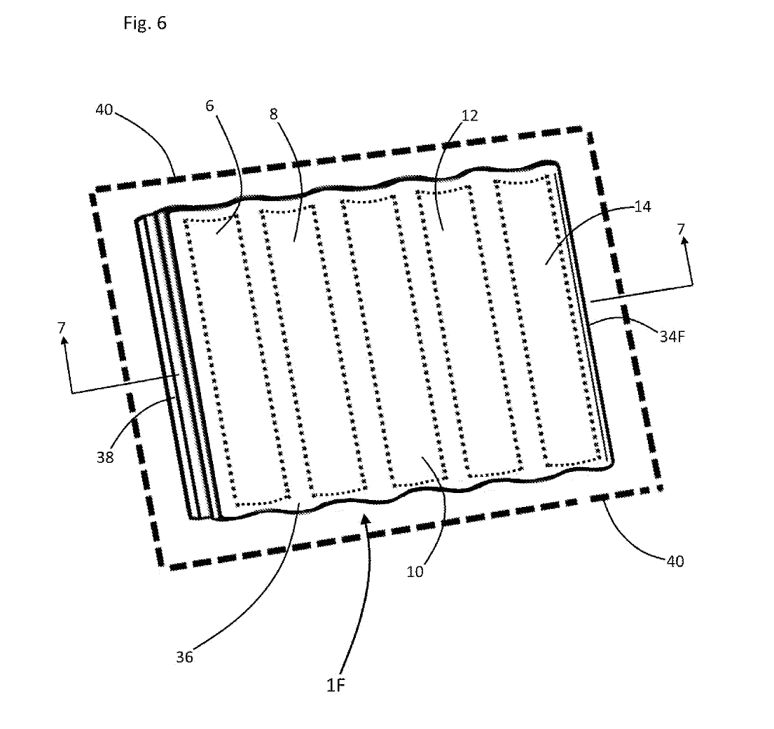

Referring now to the drawings, and in particular to Drawing FIGS. 1 and 6, extended use and folded storage configurations of the instant inventive handle cover are referred to generally by Reference Arrows 1E and 1F. Referring further simultaneously to FIGS. 3 and 4, a series of specially adapted Hunter springs 6, 8, 10, 12, 14, 16, 18, 20, 22 and 24, are incorporated within the cover 1E,1F.

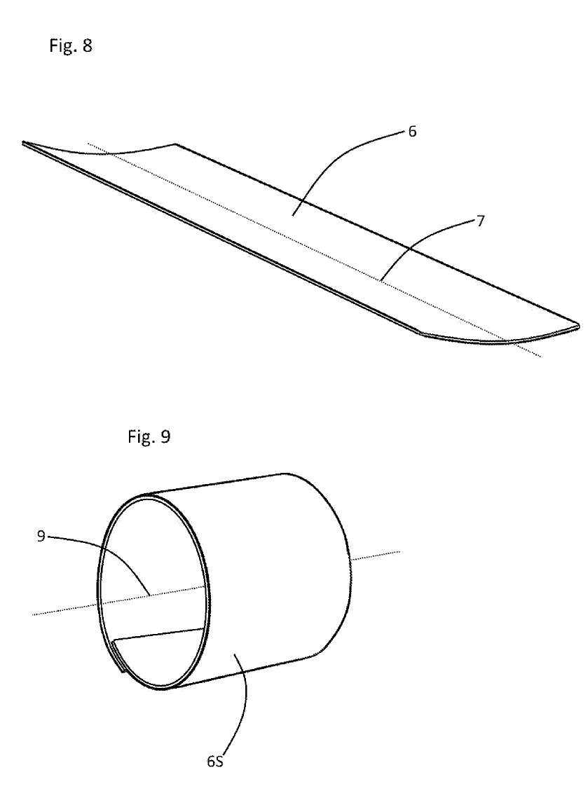

Each of the Hunter springs 6-24 is preferably formed and configured substantially identically with the single Hunter spring 6,6S, which is depicted in FIGS. 8 and 9. Similarly with conventional Hunter or constant force springs, the Hunter springs 6-24 of the instant invention include plastic memory characteristics which normally spirally curve the springs about a lateral axis 9 to assume the substantially cylindrical configuration depicted in FIG. 9. In the instant invention, each Hunter spring is preferably further and alternatively normally curved in the radially inward direction (with reference to the radial dimension of the substantially circular configuration depicted in FIG. 9) as indicated in FIG. 8. In the FIG. 8 configuration, the spring constant associated with such normal radially inward curvature has a stable equilibrium line 7 which overlies or is positioned radially outwardly from the wall of the spring. In contrast, the second normally spirally curved configuration of spring 6 in FIG. 9 has a radially inwardly positioned stable equilibrium line which coincides with axis 9. Provided that the spring constant associated with the radially inward stable equilibrium line 9 is less than the opposing spring constant associated with the radially outward equilibrium line 7, a positioning of the spring 6 at the flattened or extended FIG. 8 configuration effectively “locks” the spring at such configuration. Such locking action resists any movement of the spring toward the second normal spiral configuration of FIG. 9.

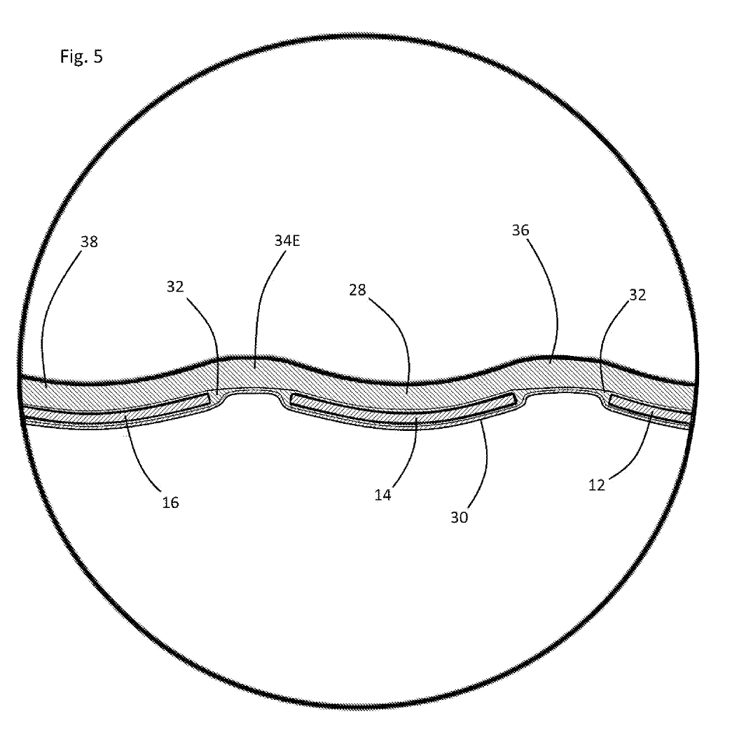

Incorporation of plastic or spring memory characteristics within the Hunter springs 6-24 to produce such dual and opposing lines of stable equilibrium facilitates the instant invention's advantageous functions which are further described below. Referring simultaneously to FIGS. 1, 4, and 5, the cover 1E comprises at least a first flexible sheet which is preferably configured as a laterally oblongated rectangle 28. In the preferred embodiment, such at least first sheet is composed of cushioning neoprene elastomeric foam. Suitably, such sheet may be alternatively composed of plastic sheet material, plastic film, elastomeric or rubber film, or woven fabric. Means for mounting the Hunter springs 6-24 upon the at least first flexible sheet 28 are necessarily provided, such means preferably comprising an adhesive 32. Suitably, the Hunter springs' mounting means may alternatively comprise stitched seams, spring receiving pockets, or slots formed within the flexible sheet(such alternatives not being depicted within views). In the preferred embodiment, a protective layer of woven synthetic fiber fabric 30 is adhesively bonded over the exposed surfaces of the Hunter springs 6-24.

In use of the instant inventive handle cover, referring to FIGS. 1-5, 8, and 9, a shopper may initially configure the cover to assume the substantially flat 1E configuration as depicted in

FIG. 1. In that configuration, each of the Hunter springs 6-24 is initially extended and locked in an over-center spring biasing fashion as indicated in FIG. 8. Thereafter, the shopper may position the handle cover 1E directly adjacent to and extending laterally along the handle 4 of the shopping cart 2. Thereafter, the shopper may press the cover 1E downwardly against the shopping cart handle 4. Such pressure causes the longitudinal and oppositely longitudinal ends of the cover 1E to deflect and counter pivot about the cart handle 4. Such counter pivoting deflection causes each of the Hunter springs 6-24 to bend about its second stable axis 9. The shopper applied bending pressure is additive to the springs' second spring constants, overcoming the first spring constants at equilibrium lines 7. Accordingly, such downward pressure frees the Hunter springs 6-24 for spiraling movements toward their second normal configurations.

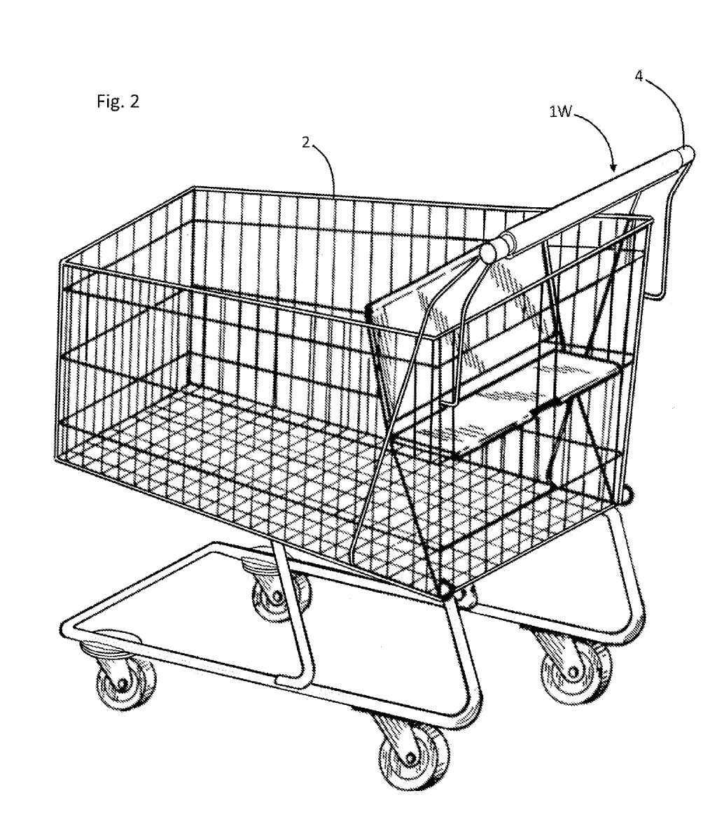

Such pressure induced spring motions automatically wrap the handle cover 1E around the shopping cart handle 4 to produce the 1W cylindrical handle protecting configuration of FIG. 2. Manual uncurling of the cover 1W, followed by manual straightening and flattening of each of its Hunter springs 6-24, returns the cover to and re-locks the cover at the 1E configuration.

Following a shopper's reconfiguration of the handle cover at the 1E configuration, the cover may be easily and conveniently halved or over-folded about a living hinge 34E. In the preferred embodiment, such hinge 34E is formed by a mid-line portion of the flexible sheet 28 which resides between and extends longitudinally along springs 14 and 16. Such over-folding advantageously positions the cover at the 1F configuration depicted in FIG. 6.

The FIG. 6 configuration represents the instant inventive covers' functional incorporation of a hinge 34F and leaves 36 and 38 combination, such combination allowing the lateral hinge leaf 36 to co-extend with and abuttingly overlie the oppositely lateral hinge leaf 38. Correspondingly, upon hinged movement to the 1F configuration, the Hunter spring lateral plurality 6, 8, 10, 12, and 14 which resides within lateral leaf 36 directly overlies the other leaf's oppositely lateral Hunter spring plurality 16, 18, 20, 22, and 24.

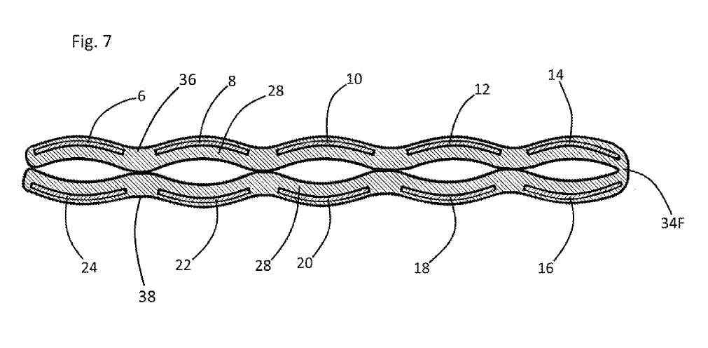

The oppositely facing and abutting matrix of springs depicted in FIG. 7 allows each of the Hunter springs 6, 8, 10, 12, and 14 within the lateral leaf 36 to oppose deflections and bending of the Hunter springs 16, 18, 20, 22, and 24 within the oppositely lateral leaf 38. Accordingly, in the over-folded configuration 1F depicted in FIGS. 6 and 7, the Hunter springs 6-24 advantageously assist each other in their maintenance of their spring locked FIG. 8 configurations. Such over-folded and abutting orientations of the springs assist in the cover's continued and uninterrupted performance of the invention's alternative compact storage function.

In order to facilitate the face to face or one to one alignments of the Hunter springs depicted in FIG. 7, the total number of Hunter springs incorporated within the cover is preferably even, with half of such number residing in each of the cover's lateral and oppositely lateral leaves. While the ten Hunter springs 6-24 depicted in the figures represents a preferred spring series, fewer or greater numbers of Hunter springs may be alternatively incorporated into the inventive handle cover, and such fewer or greater numbers of springs are considered to fall within the scope of the invention.

The dashed line box 40 drawn upon FIG. 6 represents the internal spaces or confines of purses and baby bags which are commonly carried during grocery store shopping trips. At the commencements and terminations of such shopping trips, the inventive handle cover may be secured in its compact FIG. 6 1F configuration for convenient extractions from and insertions into such purse or baby bag 40. Box 40 is alternatively representative of a rectangular and transparent sales display container, the invention's alternative compact storage function further facilitating such product display.

While the principles of the invention have been made clear in the above illustrative embodiment, those skilled in the art may make modifications in the structure, arrangement, portions and components of the invention without departing from those principles. Accordingly, it is intended that the description and drawings be interpreted as illustrative and not in the limiting sense, and that the invention be given a scope commensurate with the appended claims.

The invention hereby claimed is:

1. A handle cover for alternate compact storage and envelopment of a shopping cart handle, the handle cover comprising:
(a) a laterally extending series of Hunter springs, each Hunter spring among said series being alternatively normally radially inwardly curved and normally spirally curved;
(b) at least a first flexible sheet; and
(c) means for mounting the laterally extending series of Hunter springs upon the at least first flexible sheet, said means arranging the laterally extending series of Hunter springs for, upon the radially inwardly curving of said springs, upon an adjacent positioning of the at least first flexible sheet with respect to the shopping cart handle, and upon subsequent radially outward straightenings of said springs, spirally wrapping said springs and the at least first flexible sheet around the shopping cart handle.

2. The handle cover of claim 1 wherein the flexible sheet is composed of a material selected from the group consisting of elastomeric foam, elastomeric film, and woven fabric.

3. The handle cover of claim 2 wherein the laterally extending series of Hunter springs comprises lateral and oppositely lateral pluralities of Hunter springs, and further comprising a hinge and leaves combination, said combination's hinge comprising a portion of the at least first flexible sheet residing between the lateral and oppositely lateral pluralities of Hunter springs, and said combination's leaves comprising portions of the at least first flexible sheet respectively extending laterally and oppositely laterally from said combination's hinge.

4. The handle cover of claim 3 wherein the hinge and leaves combination's leaves are pivotable about said combination's hinge between storage and use positions, the laterally and oppositely lateral portions of the at least first flexible sheet co-extending upon pivoting to their storage positions.

5. The handle cover of claim 4 wherein, upon the pivoting of the hinge and leaves combination's leaves to their storage positions, each plurality of Hunter springs among the lateral and oppositely lateral pluralities of Hunter springs resists radially outward straightenings and spiral curvings of the other plurality of Hunter springs.

6. The handle cover of claim 5 wherein the means for mounting the laterally extending series of Hunter springs upon the flexible sheet comprise adhesive bonds.

7. The handle cover of claim 6 wherein the number of Hunter springs among the laterally extending series of Hunter springs is even, and wherein the number of the Hunter springs among each of the lateral and oppositely lateral pluralities of Hunter springs is equal to half of said even number.

8. The handle cover of claim 6 wherein the hinge and leaves combination's hinge comprises a living hinge.
